(19) United States
(12) Patent Application Publication
(10) Pub. No.: US 2011/0191339 A1
(43) Pub. Date: Aug. 4, 2011

(54) PERSONALIZED VIDEO RETRIEVAL

(76) Inventors: Krishnan RAMANATHAN, Bangalore (IN); Prasad Nagalakshmi Gali, Bangalore (IN); Vidhya Govindaraju, Bangalore (IN)

(21) Appl. No.: 12/754,633

(22) Filed: Apr. 6, 2010

(30) Foreign Application Priority Data
Jan. 29, 2010 (IN) 231/CHE/2010

(51) Int. Cl. G06F 17/30

(52) U.S. Cl. 707/732; 707/769; 707/E17.014

(57) ABSTRACT

Presented is a method and system for personalized video retrieval. The method includes specifying a user's video interests as channels, wherein each channel corresponds to a distinct video interest, querying at least one video source upon selection of a channel by the user, retrieving videos corresponding to the channel selected by the user, obtaining a personalized ranking of the retrieved videos from the user, and presenting videos for viewing based on the user ranking.

### RELATED APPLICATIONS

Benefit is claimed under 35 U.S.C. 119(a)-(d) to Foreign application Serial No. 231/CHE/2010 entitled “PERSONALIZED VIDEO RETRIEVAL” by Hewlett-Packard Development Company, L.P., filed on Jan. 29, 2010, which is herein incorporated in its entirety by reference for all purposes

### BACKGROUND

The advent of internet has given a new meaning to recording and sharing of videos. High speed broadband access to the internet, faster computer processors, increased storage capacity, etc. have provided enough reasons for people to record and share videos. Taking advantage of the increased user interests in the video sharing space, a number of portals or websites, such as, YouTube, Yahoo video and MSN video, have emerged on the internet, which allows a user to upload, view, share and download, almost unlimited number of videos. It is estimated that there are 300 million videos on the web today and thousands of videos are getting uploaded everyday to video sites on the internet. However, the present online video portals provide a very limited experience in terms of user interaction. It's largely modeled on text search wherein a user has to enter a key word to view the videos of his or her choice. In case the user wants to view videos on different video sites, he or she is required to present the same text query each time to each site. Considering a user's video interests are long lived and stable, there is no mechanism to indicate a persistent topic interest. Further, since videos on the web portals are generally ranked based on aggregate crowd behavior, the ranking may be inappropriate for an individual. Also, continuous internet connectivity is required to watch a video. Unfortunately, the places where a user may have more time to watch the video (example, an airport) are more costly in terms of connectivity. In terms of sharing of videos also, there is no mechanism to inform a video player to retrieve a video recommended through an email link and make it available to a user as and when the video player is launched.

### BRIEF DESCRIPTION OF THE DRAWINGS

For a better understanding of the invention, embodiments will now be described, purely by way of example, with reference to the accompanying drawings, in which:

FIG. 1 shows a system for retrieving personalized videos according to an embodiment of the invention.

FIG. 2 shows a flow chart of a method of retrieving personalized video according to an embodiment of the invention.

FIG. 3 shows the main screen of an exemplary user interface for retrieving personalized video according to an embodiment of the invention.

FIG. 4 shows another screen of an exemplary user interface of FIG. 3 for retrieving personalized video according to an embodiment of the invention.

FIG. 5 shows another screen of an exemplary user interface of FIG. 3 for retrieving personalized video according to an embodiment of the invention.

FIG. 6 shows another screen of an exemplary user interface of FIG. 3 for retrieving personalized video according to an embodiment of the invention.

FIG. 7 shows another screen of an exemplary user interface of FIG. 3 for retrieving personalized video according to an embodiment of the invention.

FIG. 8 shows the main screen of an exemplary user interface of FIG. 3 for retrieving personalized video according to an embodiment of the invention.

FIG. 9 shows another screen of an exemplary user interface of FIG. 3 for retrieving personalized video according to an embodiment of the invention.

FIG. 10 shows the main screen of an exemplary user interface of FIG. 3 for retrieving personalized video according to an embodiment of the invention.

### DETAILED DESCRIPTION OF THE INVENTION

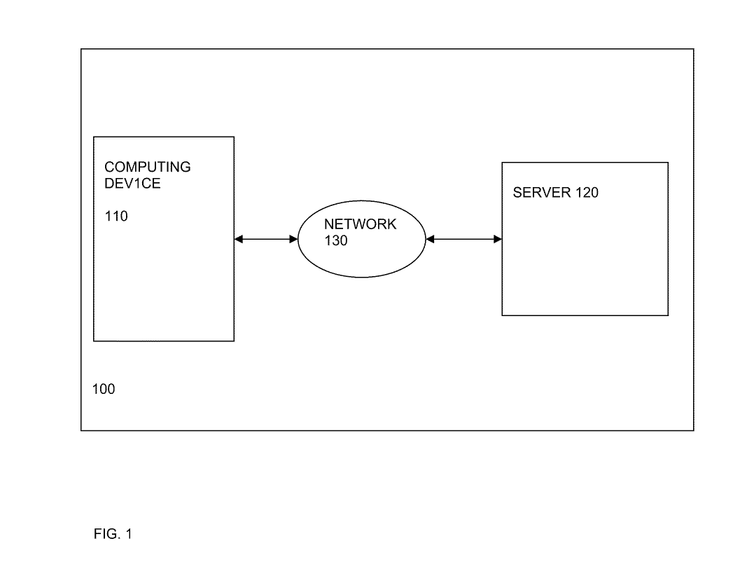

FIG. 1 shows a diagram illustrating a system 100 for retrieving personalized video according to an embodiment.

The system 100 includes a computing device 110 and a server 120. Although only one device 110 and a server 120 have been illustrated in FIG. 1, it would be appreciated that an embodiment of the invention may be implemented in a multi-device and multi-server architecture. Further, embodiments of the invention may be implemented in other computer architectures as well.

The computing device 110 may be any kind of electronic device, such as, but not limited to, a personal computer, a desktop computer, a laptop computer, a notebook computer, a network computer, a personal digital assistant (PDA), a mobile device, a hand-held device, or any other suitable electronic device.

Both the computing device 110 and server 120 may include a processor and a memory. These components may be coupled together through a system bus. The memory may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc.

The memory may store a number of programs including an operating system, application programs and other program modules. A user may enter commands and information into the client device through input devices, such as a keyboard, a touch pad and a mouse. A monitor (not shown) is used to display textual and graphical information.

The computing device 110 may include, in memory, a web browser. A web browser is a computer application that is typically used to access, retrieve and display a web page or a web site. Some of the web browsers that may be used are Internet Explorer, Opera, Mozilla Firefox and Google Chrome.

A user interface (not shown) on the computing device 110 may be used to retrieving personalized videos.

The server 120 may be any combination of hardware or software designed to provide services to client devices such as computing device 110. The server 120 typically runs a server operating system such as, but not limited to, Windows NT, HP Unix, Sun Solaris and Linux.

In an embodiment, the computing device 110 and server 120 are connected together through a network 130. The network may be the internet, an intranet or an extranet. The computing device 110 and server 120 may get connected to the network 130 via a wired or wireless connection.

It would be appreciated that the hardware components depicted in FIG. 1 are for the purpose of illustration only and the actual components may vary depending on the computing architecture deployed for implementation of the present invention.

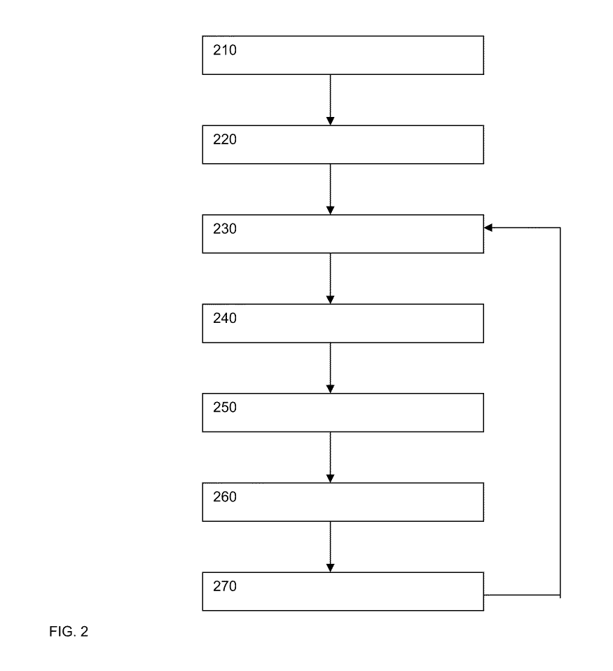

FIG. 2 shows a flow chart of a method 200 of retrieving personalized video according to an embodiment of the invention.

Step 210 includes specifying a user's video interests as channels. A user may be interested in videos on a particular subject or topic of his or her choice for a period of time. The users are requested to enter the topics they are interested in (i.e. video interests) as channels, wherein each channel corresponds to a distinct video interest.

To illustrate, if a user is interested in watching videos on cricket, the user may specify this as a channel. A channel may be any topic of interest to the user; in this case, the channel may be termed as “Cricket”. A user may specify his or her interest either explicitly or implicitly. To illustrate, a user interface may be provided for a user to enter his or her choice of topics. These topics would be channels. The information regarding a user's interest may also be collected from his profile stored in the system, which could be either local (for example, user's personal computer) or remote (for example, a server hosting a user's blog, social network profile, etc.). So, in a scenario, where the information gathered from scanning a user's profile, indicate multiple user interests (for example, movies, golf, news, stocks, etc.), the method present these interests to a user in the form of channels, which a user may select and store, or disregard and delete. However, a user always has the option to add, modify, or delete channels.

Channels are also implicitly discovered based on a user's profile or context. The user's video interests may be obtained from automatic scanning of the user's profile, user's online interactions and user's persona. In one embodiment, the profile topics are queried to online video websites (example, YouTube) and based on the number of videos returned and a predefined threshold, the profile topic is labeled as being of “video interest”. In another embodiment, profile topics that match the text description of the videos when the user is browsing videos on a video website are used to determine video interests. To illustrate, if “golf” is discovered to be a topic of interest from a user's profile, then as and when a user browses through a video website, the method presents the user with videos on “golf” and offers to add the topic of interest, in this case, “golf”, as a channel. Collaborative filtering may also be used to gauge a user's interests. For example, if a user is a member of an online group, the group's discussion threads may be mapped to analyze what are popular topics within the group. These topics may be offered as channels to the user.

Step 220 includes providing a user an option to interactively expand or create a video query (“channel”). The method allows obtaining a user's video interests through an expanded video query, wherein the expanded video query may include a set of words related to the query. The set of related words in the expanded video query may be obtained from the user's social profile.

To illustrate, if a user enters a video query on “trains”, the method provides multiple expansion options for a user to choose from and expand his or her earlier query on “trains”. For example, some of these expansion options could be “railway trains”, “old trains”, “latest trains”, “China trains”, etc. These are just some of the examples that are mentioned here and it would be appreciated that the present method is in no way limited to these expansion options. Further, once a user has made a selection from these options, say, for example, “China trains”, a user may be presented further expansion options to choose from. In the present case, these options could be “China trains to Beijing”, “China trains to Shanghai”, etc. Thus, there is potentially no limit to the level of expansion options a user may choose from, until a user is satisfied with his or her video search query.

The method allows a user to interactively select or modify an original query or an expanded query. For example, the method allows a user to select a query using natural interfaces such as touch, gestures and speech, apart from usual input interfaces, such as a mouse and keyboard.

The query expansion may use a user's profile and context information whenever available, either through a user's local machine or a remote server. In another embodiment, the words (text) in the expanded query may get selected automatically (for example, by using information theoretic measures such as mutual information). In another embodiment, a set of related words for expanding the query are displayed to a user and the user may make a selection by touching the preferred words (in the expanded query) on a display screen.

Step 230 includes querying at least one video source for the selected channel topic and retrieving the video information. To illustrate, once a user selects a channel, for example, “golf”, the method queries multiple video sources (for example, YouTube, Yahoo videos, etc.) for the selected channel topic, in this case, “golf”, and retrieves video information on “golf”. The information is generally presented in XML (Extensible Markup Language) format and gives details such as the title of the video, the url of the video, a description of the content, tags provided by online users, average ratings of the video, number of times the video has been viewed etc.

In another embodiment, the method allows a user to specify a video RSS (Really Simple Syndication) or a text RSS (containing video links) as the channel specification. The RSS is periodically retrieved and video descriptions are extracted. Users may right-click on a video link and send it to a channel location for fetching and caching at a later stage. Users may also subscribe to a blog and videos in the blog are fetched whenever the blogger recommends a video.

In another embodiment, the method periodically scans a user's email and/or blogs for video links and retrieves video descriptions upon finding a video link(s).

Step 240 includes caching or storing retrieved videos for offline viewing. A user may specify the number of videos that may be cached on his or her computer system. In an embodiment, initially N videos (N is selected by the user based on available disk space, for example N=10) are retrieved and cached using the video url information. In another embodiment, the user may input his or her preferences for selecting videos. To illustrate, a preference based on the duration of the video may be specified. For example, a user may specify that 40% videos should be less than 5 minutes duration, another 40% of between 5 and 20 minutes duration, 20% greater than 20 minutes duration etc. The videos would be downloaded based on user's specification. The selection may also take place based on the storage capacity of the device. For example, only one video from each channel may be a cached on a netbook with limited hard disk and ten videos from each channel may be cached on a laptop or a desktop, with a bigger storage capacity.

In another embodiment, a user's preference may be based on the day of the week. For example, if the viewer viewed music videos on a specific weekday (Sunday), the method allows caching of more music videos on Sunday. The user is also allowed to specify times of downloads to take advantage of “free download” windows provided by broadband companies or to take advantage of other free download zones (for example, a Wi-fi enabled mall or airport).

Step 250 includes presenting videos to a user for viewing. Upon selection of a channel, videos pertinent to the channel are presented to a user for viewing. To illustrate, if a user selects the “golf” channel, videos related to “golf” are presented to the user for viewing. The videos may be presented from the collection of videos cached earlier or from video sites, if the user is online. Further, the videos may be presented using tag clouds and/or thumbnails.

In another embodiment, videos based on past ranking by a user are presented ahead of the others. The videos are presented for viewing based on the user ranking. Ranking of the videos by a user is described in step 260. In a still another embodiment, apart from videos, advertisements and web pages related to the query topics are presented to a user for viewing.

Step 260 includes obtaining a personalized ranking of the retrieved videos from a user. The user is requested to rank the presented videos. The ranking may be Boolean (liked, disliked) or on a continuous gradation (such as a five star rating). The ranking may be used to decide which videos are retrieved and cached in future. This may be done as follows. First, the high frequency words in the video title, descriptions and tags and other text features are extracted for videos ranked by the users. This information is used to train a classifier (for example a Support Vector Machine (SVM) classifier) to predict a Boolean rating (liked/disliked) or to predict the ranks for all the other videos. The top N videos are retrieved and the user is allowed to rank the videos again.

In another embodiment, the method allows presentation of similar videos and text content related to the video being viewed. An interface may be provided for users to request videos similar to the ones they are viewing. The most salient keywords or key phrases from the video description are used to query the video source to retrieve the similar videos. A new channel is created and populated with videos similar to the current one. Thumbnail images of the videos similar to the current video are displayed. On selecting a thumbnail, the corresponding video is streamed and played.

In another embodiment, an interface may be provided for users to request text documents related to the current video. For example, if the video is about cooking, the text document would be the recipe. The method allows the user to consume a printable document related to the current video in the context of the video. The document may appear on the same device as the video or on a different device (e.g. User's laptop or mobile device). The document may then be stored or printed on a connected printer.

Step 270 includes refreshing of queried videos. If all the video links or URL (Uniform Resource Locator) fetched in step 230 are exhausted, a fresh query is made to the video sources as in step 230, and steps 230-260 are repeated. The newly retrieved videos are presented to the user for viewing.

It would be appreciated that unless explicitly stated, the method embodiments described herein are not constrained to a particular order or sequence. Additionally, some of the described method embodiments or elements thereof can occur or be performed at the same point in time.

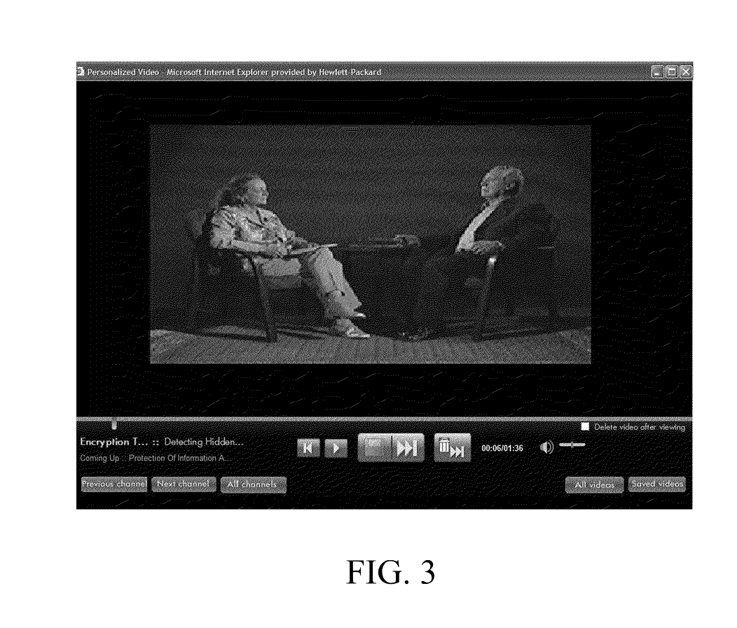

FIG. 3 shows the main screen of an exemplary user interface for retrieving personalized video according to an embodiment of the invention.

The user interface shows a video being played on a display device. The video being played is selected from a pre-defined channel. The various channels that are available to a user are provided in the form of an “All Channels” option on the user interface. A user has the option to select an earlier channel through the “Previous Channel” option on the interface, and a latter available channel through the “Next Channel” option. A user also has the option to play, pause, stop, fast-forward and rewind a video. There is also a provision to view all “All videos” and “Saved videos”. Options to delete and save a video are also available. The interface also shows the length of video being played (with the time elapsed) along with an option to adjust the volume of the soundtrack accompanying the video.

It would be appreciated that the user interface described herein along with its associated user components is for the purpose of illustration only, with many other variations being possible to the people skilled in the art. Further, the user interface described above may be implemented in the form of a computer program, computer application, and the like.

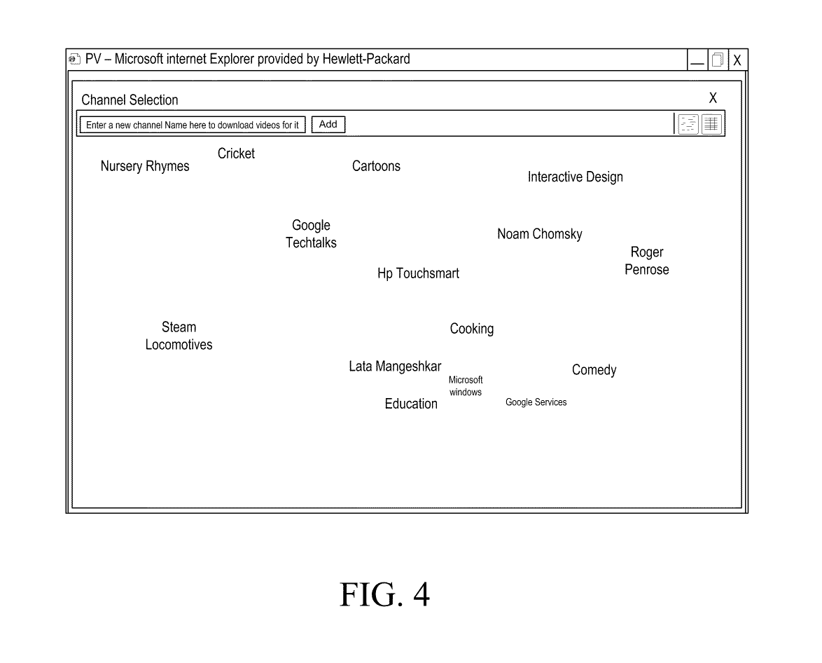

FIG. 4 shows another screen of the exemplary user interface of FIG. 3 for retrieving personalized videos according to an embodiment of the invention.

The user interface shows some exemplary channels that may be created by a user. Some of the channels shown are: cricket, steam locomotives, cooking, cartoons, comedy, etc. It would be appreciated that this is list is just exemplary and any number of channels may be created by a user.

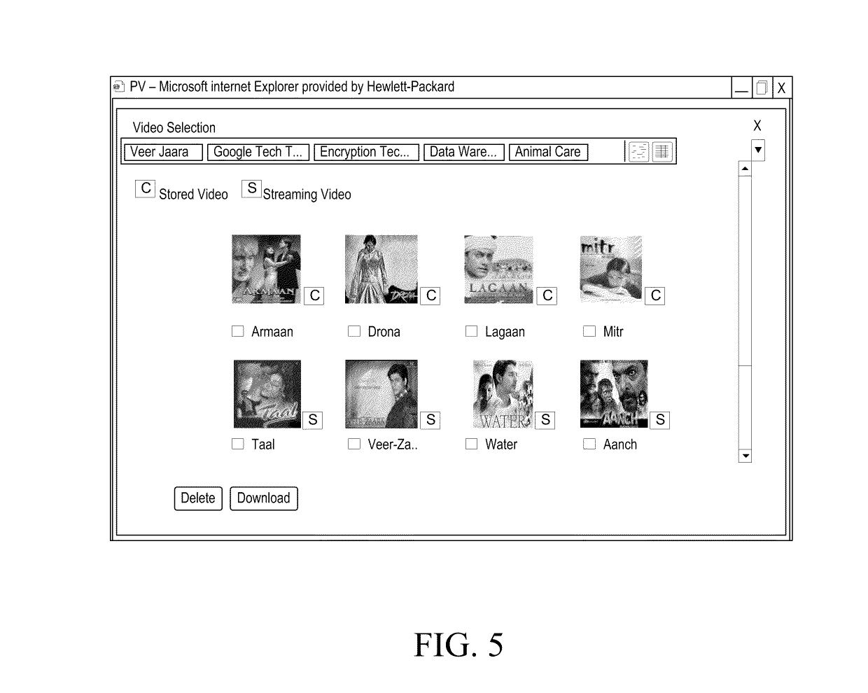

FIG. 5 shows another screen of the exemplary user interface of FIG. 3 for retrieving personalized videos according to an embodiment of the invention.

The user interface allows selection of videos for downloading to a user's computer system. The interface shows various available channels and upon selection of a channel displays the videos pertinent to the selected channel. In the present example, a user has selected the channel, “Veer Jaara”. Upon selection, the interface displays all videos related to “Veer Jaara” along with the options to delete and download a video(s).

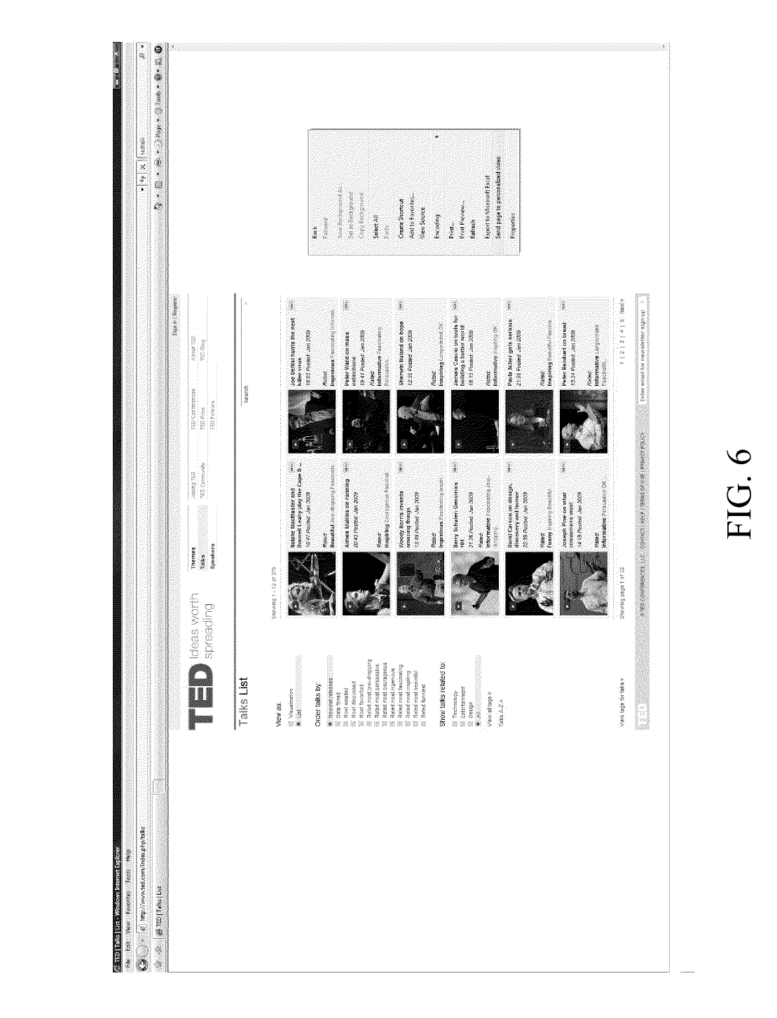

FIG. 6 shows another screen of the exemplary user interface of FIG. 3 for retrieving personalized videos according to an embodiment of the invention.

The user interface provides an option of subscribing videos from a blog RSS. In the present illustration, an option is provided on a drop down or a menu list, which allows a user to send a video page of his or her interest to a personalized video category, i.e. a channel.

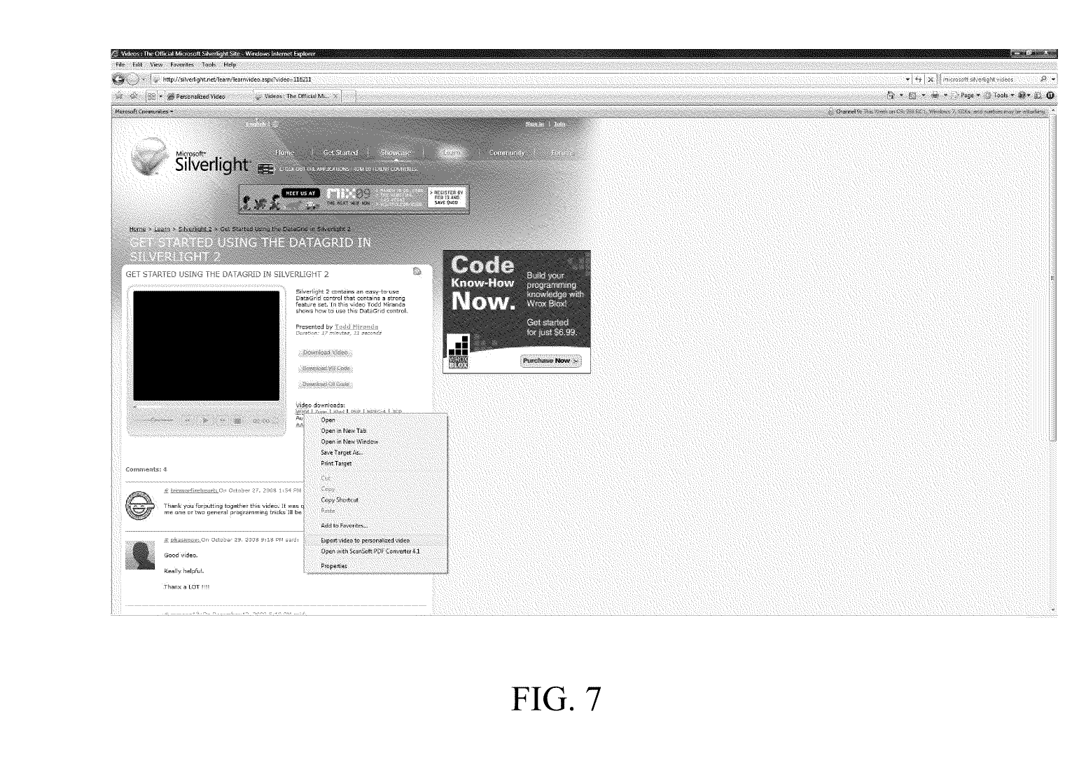

FIG. 7 shows another screen of the exemplary user interface of FIG. 3 for retrieving personalized videos according to an embodiment of the invention.

The user interface provides another option to a user to export a video from a web link received, for example through an email, to a personalized video category (a channel).

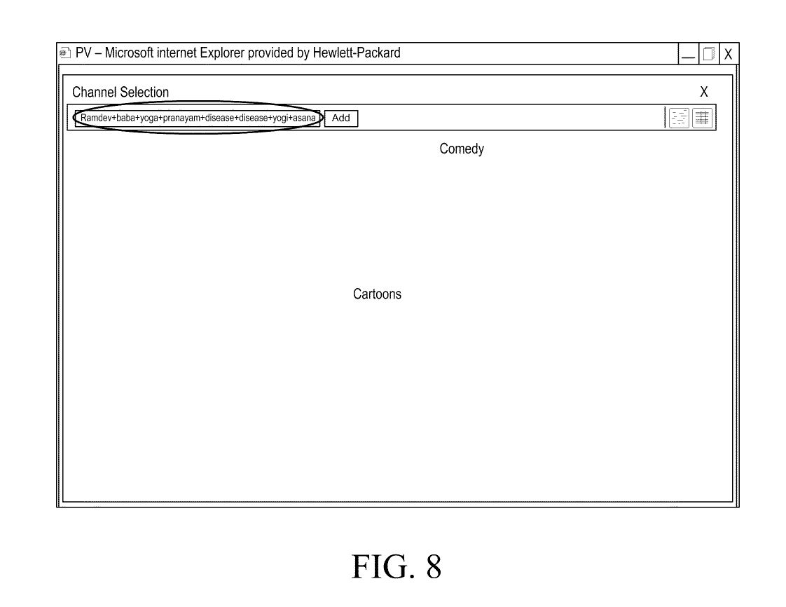

FIG. 8 shows another screen of the exemplary user interface of FIG. 3 for retrieving personalized videos according to an embodiment of the invention.

The user interface provides an option to expand a query. In the present illustration, original query “Ramdev” is expanded by providing further key words (baba+yoga+pranayam, etc.). The query expansion may take place interactively, through gestures, touch, etc.

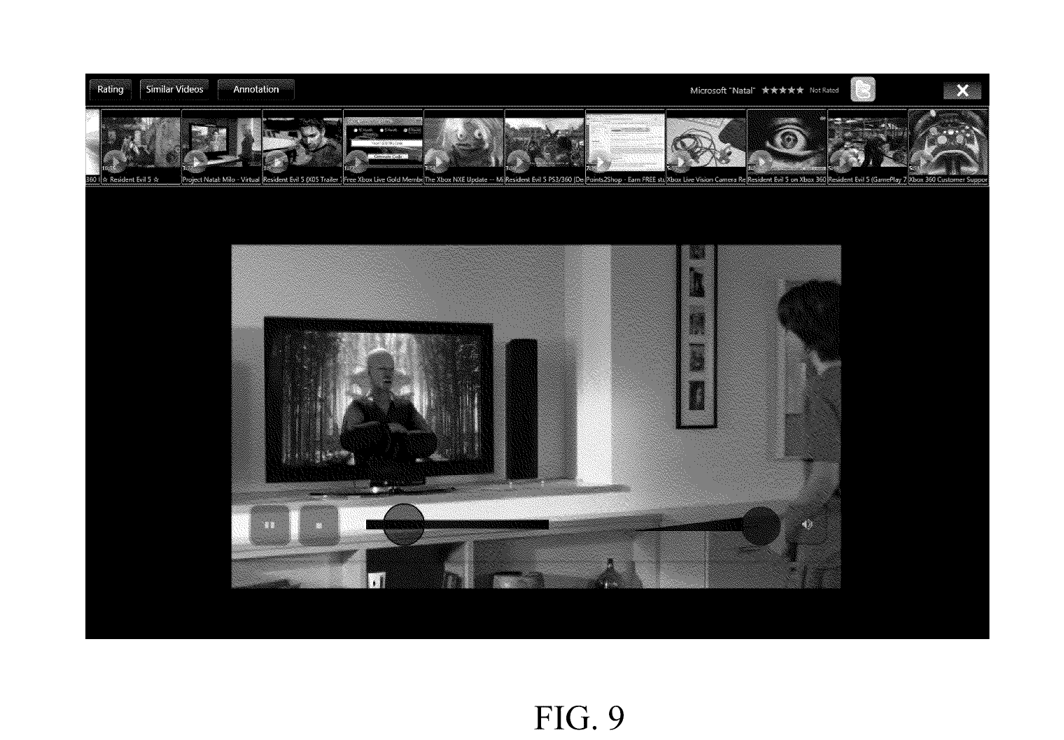

FIG. 9 shows another screen of the exemplary user interface of FIG. 3 for retrieving personalized videos according to an embodiment of the invention.

The user interface provides an option to view videos similar to the one the user is currently watching. Thumbnail images of the videos similar to the current video are displayed. On selecting a thumbnail, the corresponding video is streamed and played. The screen also displays an interface for users to rate videos and tweet the video url on their social network (in this case on twitter account).

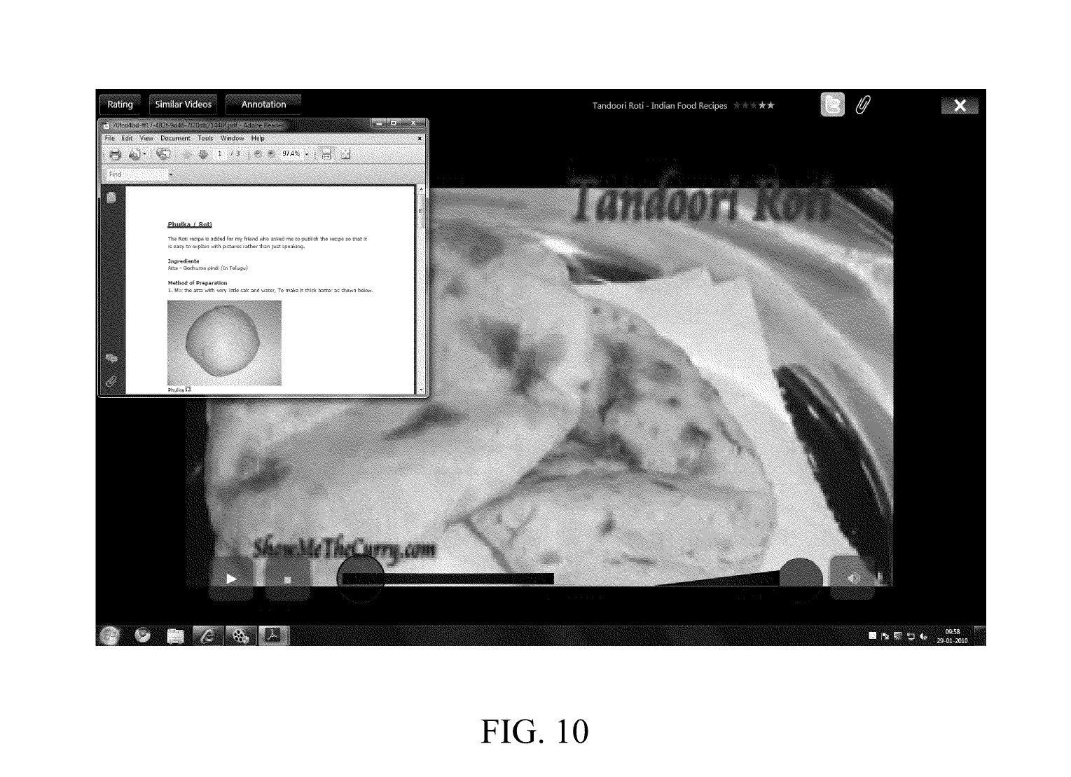

FIG. 10 shows another screen of the exemplary user interface of FIG. 3 for retrieving personalized videos according to an embodiment of the invention.

The user interface allows the user to consume a printable document related to the current video in the context of the video. The document may appear on the same device as the video or on a different device (e.g. User's laptop or mobile device). The document may then be stored or printed on a connected printer. In the present illustration, the user is presented with the text recipe for making a dish (roti) while watching a video on making the dish.

It would be appreciated that the embodiments described above frees a user from visiting multiple video sites for videos on a topic. It allows persistent video interest to be specified once and provides the users content on the specified topic for as long as the user wished. It utilizes the user feedback (like or dislike ratings, ratings on 1-5 scale) to re-rank the videos for that user. Thus, it provides an incentive to users to rate videos viewed by them. The feedback is elicited in a natural manner through implicit methods (gaze) and explicit methods (touch, gestures). The method provides an easy mechanism for sharing videos, thus, bridging the disconnect between email recommendations and the viewer.

It would be further appreciated that the embodiments within the scope of the present invention may be implemented in the form of a computer program product or means including computer-executable instructions, such as program code, which may be adapted to perform all or any of the above described method steps and run on any suitable computing environment in conjunction with a suitable operating system, such as, Microsoft Windows, Linux or UNIX operating system. Embodiments within the scope of the present invention may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present invention is for the purpose of illustration only. Although the invention has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present invention.

1. A method of retrieving personalized videos, the method comprising:
specifying a user's video interests as channels, wherein each channel corresponds to a distinct video interest;
querying at least one video source upon selection of a channel by the user;
retrieving videos corresponding to the channel selected by the user;
obtaining a personalized ranking of the retrieved videos from the user; and
presenting videos for viewing based on the user ranking.

2. A method according to claim 1, further comprising presenting similar videos and text content related to the video being viewed.

3. A method according to claim 1, further comprising obtaining the user's video interests through an expanded video query, wherein the expanded video query includes a set of words or phrases related to the query.

4. A method according to claim 2, wherein the set of related words in the expanded video query is obtained from the user's profile.

5. A method according to claim 2, wherein the expanded video query is obtained through a user interface comprising: touch, gesture or speech.

6. A method according to claim 1, further comprising obtaining the user's video interests from automatic scanning of the user's profile, user's online interactions and user's persona.

7. A method according to claim 1, wherein the video source comprises at least one of the following: a video web site, an email system or a blog.

8. A method according to claim 1, further comprising storing retrieved videos.

9. A method according to claim 1, wherein the retrieved videos are stored based on available storage space on the user's device.

10. A method according to claim 1, wherein the videos are retrieved depending on day of the week or according to preferential bandwidth rates set by the network provider.

11. A method according to claim 1, wherein the personalized ranking of the retrieved videos includes providing a Boolean ranking or a continuous gradation ranking.

12. A method according to claim 1, wherein the user can view similar videos and text content related to the video.

13. A system for retrieving personalized videos, the system comprising:
means for specifying a user's video interests as channels, wherein each channel corresponds to a distinct video interest;
means for querying at least one video source upon selection of a channel by the user;
means for retrieving videos corresponding to the channel selected by the user;
means for obtaining a personalized ranking of the retrieved videos from the user; and
means for presenting videos for viewing based on the user ranking.

14. A system according to claim 12, further comprising a user interface for obtaining the user's video interests through an expanded video query, wherein the expanded video query includes a set of words related to the query.

15. A system according to claim 13, wherein the user interface comprises at least one of the following: touch, gesture or speech.

16. A computer program comprising computer program means adapted to perform all of the steps of claim 1 when said program is run on a computer.

17. A computer program according to claim 15 embodied on a computer readable medium.
